(19) United States
(12) Patent Application Publication
(10) Pub. No.: US 2023/0152459 A1
(43) Pub. Date: May 18, 2023

(54) METHOD FOR DETERMINING THE MAXIMUM RANGE OF A LIDAR SENSOR, AND CORRESPONDING DEVICE

(71) Applicant: Robert Bosch GmbH, Stuttgart (DE)

(72) Inventors: Gabriela Samagaio, Maia (PT); Farooq Ahmed Zuberi, Moeglingen (DE); Joao Andrade, Santo Tirso (PT); Carl Mueller-Roemer, Stuttgart (DE); Juan Carlos Garza Fernandez, Stuttgart (DE); Sebastien Lemetter, Leonberg (DE)

(21) Appl. No.: 18/053,256

(22) Filed: Nov. 7, 2022

(30) Foreign Application Priority Data
Nov. 15, 2021 (DE) 10 2021 212 789.4

(51) Int. Cl. G01S 17/89

(52) U.S. Cl. CPC G01S 17/89

(57) ABSTRACT

A method for determining the maximum range of a LiDAR sensor. The method includes: providing a LiDAR point cloud using a LiDAR sensor, which images an environment of the LiDAR sensor at a certain point in time within a predefined field of view of the LiDAR sensor in a three-dimensional manner;

identifying at least two different point sets within the LiDAR point cloud, each imaging an area in the environment that was identified as belonging to a predefined environment object;
calculating the particular areas that are imaged by the point sets in each case, and dividing the number of LiDAR points imaging these areas by the individually imaged corresponding areas to obtain at least two different point densities;
calculating a quotient from the point densities, and using this quotient to ascertain the maximum range of the LiDAR sensor, for which a previously stored regression curve is used.

### FIELD

The present invention relates to a method for determining the maximum range of a LiDAR sensor. The method includes the step of providing a LiDAR point cloud with the aid of a LiDAR sensor, the LiDAR point cloud imaging an environment of the LiDAR sensor at a certain instant within a predefined field of view of the LiDAR sensor in a three-dimensional manner.

In addition, the present invention relates to a corresponding device.

### BACKGROUND INFORMATION

Methods using LiDAR systems (the abbreviation “LiDAR” means ‘light detection and ranging’ or light imaging, detection and ranging (in German known as ‘light detection and range measurement, constitute methods related to radar for an optical distance and velocity measurement and for a telemetry measurement of atmospheric parameters. Such systems and methods involve a form of three-dimensional laser scanning. In general, the term ‘LiDAR’ thus encompasses a series of techniques which employ laser light for measuring the distance to a certain target.

Such LiDAR systems are used in a broad spectrum of practical applications that require a contact-free distance measurement. The use of suitable optical scanning elements or the illumination/flash illumination of a certain region of a target makes it possible to obtain 3D images, which include depth information and back-scattering properties of the target. Such systems supply a 3D point cloud or a 3D point-cloud frame, which can be processed by software to obtain additional information about the environment.

As a result, 3D LiDAR imaging offers attractive possibilities for different applications in vehicles, in particular in motor vehicles where LiDAR systems are able to be used for avoiding dangers and collisions, for example. In the related art, LiDAR systems are currently used especially in the field of autonomous driving (AD) and also in the field of advanced driver assistance systems (ADAS).

In this context, the obtained data—starting from a 3D point cloud—must be (further) processed in order to detect, distinguish and classify environment objects such as vehicles, pedestrians, buildings, road surfaces or other obstacles. Such classifications are of the greatest relevance for an autonomous and driver-assisted navigation as well as for a driving assistance when decisions have to be made in the context of danger avoidance and self-steering. Different techniques and methods for an object detection and mapping that are suitable not only for terrestrial but also air-based applications have been suggested for this purpose.

Corresponding solutions are described in U.S. Pat. No. 8,244,026 B2, U.S. Patent Application Publication No. US 2016/0154999 A1 as well as U.S. Pat. No. 9,360,554 B2. Additional solutions can be found in different scientific articles such as in Matei et al, “Rapid and Scalable 3D Object Recognition Using LiDAR Data”, Proc. SPIE 6234, Automatic Target Recognition XVI, 623401 (2006) or in Himmelsbach et al., “LiDAR-Based 3D Object Perception”, Proceedings of 1st International Workshop on Cognition for Technical Systems (2008).

The techniques described there, among others, utilize the 3D information for determining the geometrical shape and edges of different objects in the illuminated scene in order to distinguish different types of targets. However, an object detection based solely on purely geometrical and dimensional characteristics is difficult, especially if the resolution of the LiDAR sensors or cameras is not very high and different types of targets have a similar geometry. In addition to the 3D mapping, LiDAR sensors also supply information about the reflection characteristics of the illuminated targets by measuring the intensity of the reflected/backscattered light. Such a solution is mentioned in the document U.S. Pat. No. 9,360,554 B2, for example.

This information may thus be used for additional assistance in the object detection and a further improvement in the differentiation and classification of targets, as also indicated in the scientific article Takagi et al. “Road Environment Recognition Using On-Vehicle LiDAR”, Intelligent Vehicles Symposium (2006). In addition, it is also possible to measure the velocity of a target by measuring the distance at different points in time.

However, there are currently no satisfactory solutions offered in the related art for estimating and quantifying the current maximum range of a LiDAR sensor or system, i.e., the maximal distance in meters, within which environment objects can still be reliably detected with the aid of the LiDAR sensor. More specifically, convincing solutions that enable a reliable determination of the maximum range of the LiDAR sensor regardless of the special environment scenery are currently not available in the related art.

However, such a range determination may provide important information, especially for applications in (motor) vehicles. For that reason, it should be possible to determine the maximum range (e.g., 300 m) of a LiDAR sensor even when the vehicle is driving in an urban area which presents many masking effects and restricted scenes on account of buildings, etc. In other words, the estimation of the maximum range of LiDAR sensors used in LiDAR systems plays an important key role and should be identifiable regardless of the current geometrical scene of the LiDAR system.

### SUMMARY

According to the present invention, a method for determining the maximum range of a LiDAR sensor is provided. According to an example embodiment of the present invention, the method includes the following steps:

Providing a LiDAR point cloud with the aid of a LiDAR sensor, which images an environment of the LiDAR sensor at a specific point in time within a predefined field of view of the LiDAR sensor in a three-dimensional manner. Identifying at least two different point sets within the LiDAR point cloud, each imaging an area in the environment that was identified as belonging to a predefined environment object. Calculating the particular areas that are imaged by the point sets in each case, and dividing the number of LiDAR points imaging these areas by the individually imaged corresponding areas in order to obtain at least two different point densities. Calculating a quotient from the at least two point densities and using this quotient to ascertain the maximum range of the LiDAR sensor with the aid of a previously stored regression curve.

Such a method offers the advantage that it allows for the detection of the maximum range of a LiDAR sensor in a reliable, stable, and efficient manner even when experiencing a “fuzzy view”, i.e., when using a 3D LiDAR point cloud which images a foggy environment, for example.

Predefined environment objects preferably represent objects in the environment and in the field of view of the LiDAR sensor, which are detectable as parts of the environment acquired with the aid of the LiDAR sensor. Predefined environment objects are most preferably objects in the environment and in the field of view of the LiDAR sensor whose occurrence in the environment and in the field of view of the LiDAR sensor may be assumed as always given, such as the surface of the ground or the base on or across which the LiDAR sensor is moving. The calculation of the areas or an area is preferably performed by mentally interconnecting, in a straight line, the points located at the periphery or the edge of the point sets to form a peripheral line and calculating the area enclosed by this peripheral line.

According to a preferred embodiment of the present invention, both the existence of the predefined environment object and its position in the field of view are determined or identified by a classification algorithm applied to the LiDAR point cloud. In such an embodiment, the detection or classification of a specific environment object may take place in a rapid, safe, and reliable manner using an algorithm provided precisely for this purpose. The classification algorithm is and/or was preferably trained for the detection or classification of a specific environment object, especially with the aid of a neural network.

The classification algorithm is preferably an algorithm by which the surface of the ground and/or the base on or above which the LiDAR sensor was situated at the time was detectable as a predefined environment object in the environment in the field of view of the LiDAR sensor. Put another way, the classification algorithm preferably is an algorithm which detects as a predefined environment object the surface of the ground or the base on which the LiDAR sensor, for instance as part of a LiDAR system installed in a motor vehicle, is moving. In a preferred refinement of this embodiment, in order to improve the detection/allocation of the ground base points or ground points as such, a further algorithm is applied to the points previously detected as such points (that is, to the LiDAR points that were detected as belonging to the ground or the surface of the ground), by which an analysis of the density of the particular points of the 3D LiDAR point cloud that image the ground or the base is carried out. In English, such a (further) algorithm is sometimes also referred to as a density of ground points (DGP) algorithm. In the German language, such a (further) algorithm is sometimes also called a ground estimation algorithm. A ground estimation algorithm or DGP algorithm of this type may also be regarded as part of the classification algorithm. In such an embodiment, especially if applications in a motor vehicle are involved, the determination of the maximum range may reliably take place at all times and independently of the specific scenery in the environment of the LiDAR sensor because motor vehicles move on some type of surface, ground or base in the generic case, and the surface of the ground or base is therefore always part of the environment acquired with the aid of the LiDAR sensor. In an advantageous manner—and in contrast to the solutions according to the related art—, the determination of the maximum range in such an embodiment does not depend on the detection of the object at the greatest distance from the LiDAR sensor by the LiDAR sensor.

According to an example embodiment of the present invention, the at least two different point sets preferably image areas that represent at least part of the surface of the ground and/or the base on or above which the LiDAR sensor was situated at that time. Prior to the step of identifying the at least two different point sets, the classification algorithm, which is developed as a ground estimation algorithm, preferably classifies as a ‘base or ‘ground’ all points from the LiDAR point cloud that represent or image the ground plane or base plane within the environment in the field of view scanned with the aid of the LiDAR sensor.

These areas may preferably lie very close to the LiDAR sensor or also far away therefrom in the field of view. If interference in the visual conditions is present, e.g., generally caused by a drop in the laser output or by unfavorable weather conditions, then LiDAR point subgroups or LiDAR point sets that are located in the vicinity of the LiDAR sensor tend to have a lower density. On the other hand, if no interference is present, then the density tends to be higher. To be robust with regard to changing surface conditions, the quotient between the densities calculated for the two regions or for the two areas is determined. The at least two areas preferably involve essentially planar areas.

Within the framework of the use of the quotient, the quotient is preferably compared to at least one regression curve previously stored for the areas imaged by the at least two different point clouds or to areas that are essentially comparable to these areas. By storing at least one regression curve for the areas or for comparable areas, it is easily and quickly possible to infer the maximum range of the LiDAR sensor from the quotient.

In one preferred embodiment of the present invention, the at least one previously stored regression curve relates the calculated quotient to the maximum range of the LiDAR sensor. The calculated quotient furthermore is preferably directly proportional to the maximum range of the LiDAR sensor. The maximum range in such an embodiment is able to be read off or derived rapidly, easily and directly from the regression curve with the aid of the quotient. The regression curve was preferably ascertained from data previously acquired for the areas and/or for comparable areas. The previously acquired data are preferably made available to a neural network, which allocated and allocates different maximum ranges to different quotients for the individually involved and/or comparable areas.

According to an example embodiment of the present invention, the regression curve preferably involves a polynomial of the second to third degree, for which the coefficients must be learned or acquired from the marked or identified data. One preferred possibility for learning/acquiring the coefficients is the use of what is known as an SVR (support vector regression). An SVR learning algorithm based thereon receives as input the quotient from the different ground sections and targets in order to output the area that is included in the ‘ground reality’ or (in English often referred to as ‘ground truth’) for a particular LiDAR image, the LiDAR image resulting from the LiDAR point cloud.

According to an example embodiment of the present invention, the at least two different point sets preferably differ from one another in at least one LiDAR point, especially in all LiDAR points. In other words, none of the LiDAR points from the first point set is included in the second point set, and vice versa. The more the LiDAR point sets that image the areas differ from one another, the more robust the method of the present invention with regard to changing surface conditions of the base or ground. If the point density for one of the at least two areas is reduced due to fog, for example, then there is lesser likelihood that the same fog also reduces the point density for the other of the at least two areas with an increasing distance between the at least two areas. Forming the quotient thus makes the method of the present invention more robust and reliable with regard to interference effects that have an adverse effect on the view of the LiDAR sensor.

According to an example embodiment of the present invention, the predefined field of view is preferably one of at least two predefined subfields of view of the LiDAR sensor, which jointly form the total field of view of the LiDAR sensor. Such subfields of view are sometimes also referred to as fields of view (FoV) in English. The method according to the present invention is preferably carried out for each subfield of view, and a maximum range is determined for each subfield of view. In such an embodiment, the maximum range for the individual subfields of view can therefore be broken down more precisely, i.e., in a manner that is more finely granulated. In this way, the LiDAR sensor is able to be utilized in a more optimal and more precise way.

In one preferred refinement of this embodiment of the present invention, a predefined rule is used to ascertain a maximum range for the total field of view based on the maximum ranges ascertained for the subfields of view. In such an embodiment, the maximum range for the entire field of view is able to be determined more precisely. The predefined rule may involve arithmetic averaging, for example.

In addition, the present invention provides a device having a LiDAR sensor, the device being designed to carry out the steps of the method according to the present invention. In such an embodiment, the advantages mentioned in connection with the method according to the invention come into effect in the device according to the present invention.

Furthermore, the device preferably includes a memory as well as a processing unit, which is designed to carry out the present method while utilizing the memory.

The field of view preferably denotes the entire acquisition field of the LiDAR sensor or a part of the entire acquisition field of the LiDAR sensor.

In addition, the LiDAR point cloud preferably denotes a georeferenced point cloud, which encompasses a multitude of LiDAR measuring points resulting from backscatter or reflections of the LiDAR light at objects in the environment.

Advantageous refinements of the present invention are disclosed herein.

### BRIEF DESCRIPTION OF THE DRAWINGS

Exemplary embodiments of the present invention will be described in greater detail with the aid of the figures and the following specification.

FIG. 1 shows a flow diagram of an exemplary embodiment of the method according to the present invention.

FIG. 2 shows an exemplary field of view of a LiDAR sensor installed in a motor vehicle.

### DETAILED DESCRIPTION OF EXAMPLE EMBODIMENTS

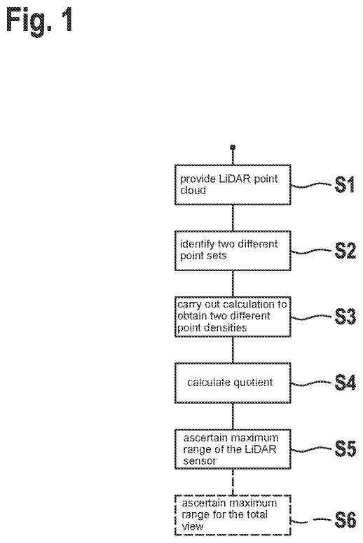

FIG. 1 shows a flow diagram of an exemplary embodiment of the method according to the present invention for determining the maximum range of a LiDAR sensor. The individual steps of the method are shown in boxes, and purely optional steps are shown in boxes featuring dashed lines. In other exemplary embodiments, the sequence of the steps of the method may deviate from the sequence shown in FIG. 1.

In a first method step S1 in this exemplary embodiment, a LiDAR point cloud is provided with the aid of a LiDAR sensor. The LiDAR sensor, for example, may be installed in a motor vehicle, and, inter alia, can also be used within the framework of an application for autonomous driving, for instance. In other exemplary embodiments, however, it may also be utilized within the framework of some other application. The LiDAR point cloud supplied in first method step S1 with the aid of the LiDAR sensor images the environment of the LiDAR sensor at a specific point in time within a predefined field of view of the LiDAR sensor in a three-dimensional manner. The individual LiDAR points thus represent georeferenced points.

Within the framework of the present exemplary embodiment, the first method step S1, just like the other steps of the exemplary embodiment of the method of the present invention described in greater detail further below, is executed quasi-continuously. In this exemplary embodiment, the maximum range for the field of view of the LiDAR sensor is therefore determined in a quasi-continuous manner. However, in other exemplary embodiments according to the present invention, the determination of the maximum range and thus the execution of the method steps of the method according to the present invention, may also always take place only at predefined time intervals such as once per millisecond, or only when predefined conditions occur, or otherwise also according to a totally different predefined rule.

In a second method step S2, two different point sets are identified within the LiDAR point cloud, each imaging an area in the environment that was detected as belonging to a predefined environment object. In this particular exemplary embodiment, this second method step S2 is first also preceded by an additional method step in which all points imaging the predefined environment object are detected as such and the predefined environment object as such is classified in this manner. However, this step is purely optional and may also be omitted in other exemplary embodiments of the method (which is why it is not depicted in FIG. 1).

In this exemplary embodiment, purely by way of example, both the existence of the predefined environment object and its position in the field of view are determined within the framework of the area identification by a classification algorithm applied to the LiDAR point cloud, which in this exemplary embodiment, merely by example, involves an algorithm by which the surface of the ground and/or base is detectable on or above which the LiDAR sensor was situated at the time when a predefined environment object is detectable within the environment of the field of view of the LiDAR sensor. In this exemplary embodiment, purely by way of example, the predefined environment object within the environment in the field of view of the LiDAR sensor thus is the surface of the ground or base which is situated in the field of view of the LiDAR sensor and detected as such by the sensor. The surface will normally involve approximately planar surfaces such as the surface of roads, traffic lanes, paths, or other driving surfaces. However, other methods according to the present invention that use other predefined environment objects and other classification algorithms are also able to be executed.

In this exemplary embodiment, the two different point sets image areas that represent part of the surface of the ground or base on or above which the LiDAR sensor was located at the time. In this exemplary embodiment, the surfaces are selected from a region of the field of view of the LiDAR sensor in which the predefined environment object, i.e., the surface of the ground or the base, is regularly located or to be expected. The areas in this exemplary embodiment are furthermore selected from a region of the field of view for which a multitude of empirical values are already stored in the form of datasets. This will be described in greater detail in the further text.

In third method step S3, a calculation of the particular areas imaged by the point sets and a division of the number of LiDAR points imaging these surfaces by the correspondingly imaged areas is carried in order to obtain at least two different point densities. In this exemplary embodiment, the LiDAR points located at the outer edge of the identified point sets/areas are thus connected to one another by a straight line, and the area enclosed by the thereby resulting connection line is calculated. In other exemplary embodiments, however, the area may also be calculated in a different manner. Next, at the same time or earlier, the number of LiDAR points imaging the respective area is determined. As a result, all LiDAR points situated in the afore-described connection line and also the LiDAR points enclosed by the connection line are summed and the total number of LiDAR points imaging the area is divided by the area itself. In other exemplary embodiments, the number of LiDAR points can also be determined in a different manner. In this way, the point densities for the areas are determined.

In a fourth step of the method, S4, a quotient is calculated from the two point densities, the greater point density being divided by the smaller point density in this exemplary embodiment. In other exemplary embodiments, however, the calculation of the quotient may also be carried out in a reversed order, that is, the smaller point density is divided by the greater point density.

In a fifth method step S5, the employed quotient is used to ascertain the maximum range of the LiDAR sensor, for which a previously stored regression curve it utilized. In this exemplary embodiment, within the framework of using the quotient, the quotient is compared to a regression curve previously stored for the areas imaged by the at least two different point sets or to areas essentially comparable to these areas. In other words, this exemplary embodiment utilizes the above-mentioned empirical values, which were determined for the different point sets imaging the predefined environment object. The at least one previously stored regression curve relates the calculated quotient to the maximum range of the LiDAR sensor. Purely by way of example, the regression curve in this exemplary embodiment results as an output dataset of a neural network. This will be described in detail in the following text for the current exemplary embodiment.

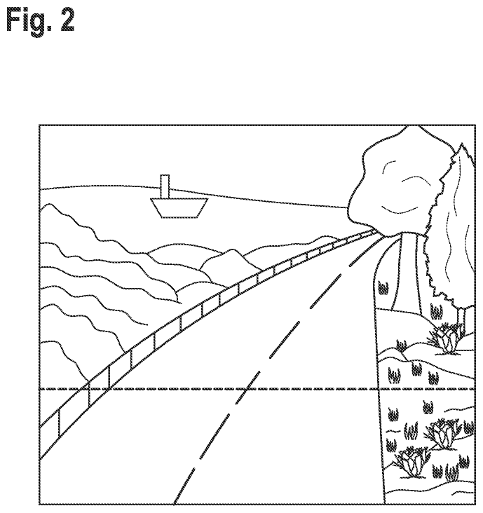

In the field of view of the LiDAR sensor, the surface of the ground or base, e.g., the road, is always acquired in similar or recurring regions of the field of view, that is, in a lower region of the field of view, because the LiDAR sensor is used in a motor vehicle. FIG. 2 schematically illustrates such a field of view by way of example; however, FIG. 2 does not show the LiDAR point cloud itself but rather the schematically represented (“real”) environment in the field of view of the LiDAR sensor, which is imaged by the LiDAR sensor with the aid of the LiDAR 3D point cloud it acquired (the LiDAR image itself is not shown in FIG. 2). In the generic case, regardless of the individual scenery, the surface of the base or ground on which the LiDAR sensor is moving or located (at the time when the LiDAR point cloud was acquired) will be shown below the dashed line within the field of view.

Within the corresponding LiDAR image, in this exemplary embodiment within the region of the LiDAR point cloud by which the region below the dashed line is imaged via LiDAR points, the above-mentioned classification algorithm is used for a multitude of “training scenes” to classify the particular LiDAR points as “belonging to the surface of the base/ground” that image the essentially planar surface in the environment (such as the road in FIG. 2). For a large multitude of possible point sets/area combinations or pairs that lie within the region below the dashed line in the 3D point cloud imaging the environment, the respective densities are then determined as described earlier, divided by one another, related to the respective scene-dependent maximum range, and stored and processed as a dataset. The respective scene-dependent maximum range may have been determined or is determined individually for each individual training scene or else also according to a predefined method.

Given poor weather conditions such as fog, other densities will occur than in the presence of bright sunshine and/or a blue sky. As a result, a different density quotient will come about and also a different maximum range of the LiDAR sensor associated with this quotient. In this exemplary embodiment, the neural network extracts from this set of data a separate regression curve for each point-set combination or area combination, which relates the respective density quotient to the maximum range of the LiDAR sensor. If a certain density quotient is then calculated for certain areas in the execution of the method according to the present invention, it is easily and rapidly possible to ascertain the maximum range of the LiDAR sensor for the density quotient based on the stored regression curve.

Expressed once again in different terms:

According to the present invention, what is often called the “ground of truth”, (or ground truth, see above) is defined at the outset, which is graphically determined with the aid of a measurement. The ‘ground of truth’ is calculated for the entire measurement and does not change over time. The above-mentioned measurement includes a target featuring a 10% reflectivity. The echoes of this target are checked for the target frame. In this exemplary embodiment, only one frame is considered every 10 m (this may depend on the measured range). It is then checked in the near range whether the expected number of points agrees with the number of measured points (no missing point). With increasing distance, it can be noticed that a few points vanish. The ratio (measured target points/expected target points) is calculated for every examined image. When this ratio drops below 90%, the current range is noted and serves as ground of truth range for the entire measurement.

One skilled in the art will understand that the above-mentioned percentages have been selected purely by way of example. Thus, the measurement may also include a target of 1%, 2%, 3%, 4% or of 5% reflectivity or of 15%, 20%, 25%, 30%, 35%, 40%, 45%, 50% reflectivity or some higher, lower, or a totally different predefined reflectivity. In addition, it is also possible to note the current range and use it as ground of truth range for the entire measurement if the afore-described ratio (measured target points/expected target points) drops below 80%, 70%, 60%, 50%, 40%, 30%, 20%, 10% or below a totally different predefined value, which can also be greater than 90%. In addition, a frame every 5 m, 15 m, 20 m or a totally different frame may be considered.

The regression curve is specific for the objects of interest or environment objects (e.g., for two areas on the road located at a distance of 5 m from each other, etc.) since the regression curve is to be learned therefrom. If the objects of interest or environment objects change (for instance if the rear side of the same truck at two predefined distances represents the object of interest or environment object), then a new regression curve must be learned for this case. Thus, if the algorithm in an exemplary embodiment is able to dynamically select which objects of interest or environment objects are to be used, then it also follows that different regression curves will be used.

It is explicitly noted at this point that it is also possible to use different classification algorithms for the classification of other predefined environment objects in other exemplary embodiments according to the present invention. Also, the density may be determined using totally different point sets, areas, or regions of the field of view. Moreover, the regression curve may likewise be determined in a totally different manner, and there is furthermore no need to use a neural network for this purpose.

In this exemplary embodiment, the examined field of view of the LiDAR sensor is not subdivided further. Only a single, so-called ‘field of view’ therefore exists. However, it is also possible to carry out other methods according to the present invention in which the total field of view of the LiDAR sensor is subdivided into different subfields of view, i.e., different fields of view, which jointly form the total field of view of the LiDAR sensor. In that case, the present method will be carried out for, or within, each individual subfield of view, and a maximum range of the LiDAR sensor is ascertained for each individual subfield of view. In a further method step, using a predefined rule, a maximum range for the total field of view may then be ascertained from the maximum ranges determined for each subfield of view. In FIG. 1, such a method step is sketched as an optional sixth method step S6 to illustrate how the flow diagram of a method according to the present would look in such an embodiment.

In other words, the method according to the present invention in the afore-described exemplary embodiment is based on the analysis of the density of the points in the ground. To classify these points as ground, a ground estimation algorithm initially estimates all points that represent the ground plane. The ground estimation algorithm is based on the assumption that the vehicle is driving on a type of ground plane, so that it is independent of the presence of the most remote objects in the scene. If an adverse effect exists such as a reduced laser output or unfavorable weather conditions, the point subgroup located in close proximity to the sensor tends to have a lower density. On the other hand, if no adverse effect is present, the density tends to be higher. To be robust with regard to changing surface conditions, the quotient between two regions (within a field of view, FoV), is calculated.

For this purpose, the present method receives the 3D point cloud for which the points belonging to the ground were previously marked by a ground detection algorithm and also—if the method according to the present invention is executed for multiple subfields of view—the sections for dividing the field of view.

Next, the following method steps are carried out:
1. The provided algorithm receives a point cloud.
2. For each subfield of view, FoV, two partial point sets, which are also referred to as patches, are prepared, for which only the points marked as ground are used.
3. Searching for two ground fields in the same subfield of view, FoV.
4. Calculating the areas of the individual ground fields.
5. Calculating the density in every ground field.
6. Calculating the quotient from the densities in an effort to reduce the influence of the surface type or the ground material.
7. Determining the maximum range of the LiDAR sensor by using the quotient in the function of the regression range curve or regression curve.
8. Outputting the distance in meters.

To identify the ground points, a ground estimation algorithm which images a virtually planar region is first applied to the 3D point cloud. The ground is not always a strictly planar surface because it may feature various depressions or elevations that are covered by this algorithm.

With the aid of this information, the density of the two selected areas is calculated and the quotient of these two densities is then ascertained. This method reduces the effect of the changing ground material or the surface type in the estimation of the range. The density quotient is directly proportional to the actual range the sensor is able to measure. To find this relationship, a curve, i.e., a regression curve, is ascertained using previously acquired and known data. In its simplest form, this function may be a linear straight line which maps the density quotient to the estimated range. The present invention is not restricted to this, however.

In an advantageous manner, this invention offers the possibility of determining the maximum range even in noisy 3D LiDAR point clouds. Moreover, it is possible to estimate the maximum range in meters for every subfield of view (FoV). This solution is furthermore independent of the scene, which means that the determination of the maximum range of the LiDAR sensor is independent of the detection of an object at the greatest distance. This provides a robust solution insofar as these real data are used.

In other words, the goal of the present invention is the estimation of the detection range of LiDAR sensors. The maximum range depends on various factors such as the reflection capacity of objects. Some factors that lead to a worsening of the detection range are weather conditions such as rain, fog, sandstorms and/or blockages in the near range, e.g., mud, bird waste, ice, snow, beetles, or leaves. In these cases, it is important that the entire ADAS/AD system be capable of adequately responding to such adverse effects. The ADAS/AD system may respond by reducing the target speed, implementing a transfer to the human driver, or by driving to the edge of the road. In addition, a limited detection range and a restricted precision of the LiDAR system may be unable to guarantee a normal operation of an ADAS/SD system.

Although the present invention was specifically illustrated and described in detail based on preferred exemplary embodiments, the invention is not restricted to the disclosed examples, and one skilled in the art may derive other variations therefrom without departing from the protective scope of the present invention.

1-10. (canceled)

11. A method for determining a maximum range of a LiDAR sensor, the method comprising the following steps:
providing a LiDAR point cloud using the LiDAR sensor, which images an environment of the LiDAR sensor at a specific point in time within a predefined field of view of the LiDAR sensor in a three-dimensional manner;
identifying at least two different point sets within the LiDAR point cloud, each of the at least two different point sets imaging an area in the environment that was identified as belonging to a predefined environment object;
calculating the area imaged by each of the point sets, and dividing a number of LiDAR points imaging the areas by imaged corresponding areas to obtain at least two different point densities;
calculating a quotient from the at least two point densities; and
using the quotient to ascertain the maximum range of the LiDAR sensor, for which a previously stored regression curve is used.

12. The method as recited in claim 11, wherein both an existence of the predefined environment object and its position in the field of view are determined by a classification algorithm applied to the LiDAR point cloud.

13. The method as recited in claim 12, wherein the classification algorithm is an algorithm by which a surface of the ground and/or a base on or above which the LiDAR sensor was situated at that time is detectable as a predefined environment object within the environment of the field of view of the LiDAR sensor.

14. The method as recited in claim 13, wherein the at least two different point sets image areas that represent at least part of the surface of the ground and/or the base on or above which the LiDAR sensor was situated at that time.

15. The method as recited in claim 11, wherein within a framework of use of the quotient, the quotient is compared to at least one regression curve previously stored for the areas imaged by the at least two different point sets or to areas that are comparable to the areas.

16. The method as recited in claim 15, wherein the at least one previously stored regression curve relates the calculated quotient to the maximum range of the LiDAR sensor.

17. The method as recited in claim 11, wherein the at least two different point sets differ from one another in at least one LiDAR point.

18. The method as recited in claim 11, wherein the at least two different point sets differ from one another in all LiDAR points.

19. The method as recited in claim 11, wherein the predefined field of view is one of at least two predefined subfields of view of the LiDAR sensor, which jointly form a total field of view of the LiDAR sensor.

20. The method as recited in claim 19, wherein a predefined rule is used to ascertain a maximum range for the total field of view based on maximum ranges ascertained for the subfields of view.

21. A device, comprising:
a LiDAR sensor;
wherein the device to determine a maximum range of the LiDAR sensor, the device configured to:
provide a LiDAR point cloud using the LiDAR sensor, which images an environment of the LiDAR sensor at a specific point in time within a predefined field of view of the LiDAR sensor in a three-dimensional manner,
identify at least two different point sets within the LiDAR point cloud, each of the at least two different point sets imaging an area in the environment that was identified as belonging to a predefined environment object,
calculate the area imaged by each of the point sets, and dividing a number of LiDAR points imaging the areas by imaged corresponding areas to obtain at least two different point densities,
calculate a quotient from the at least two point densities, and
use the quotient to ascertain the maximum range of the LiDAR sensor, for which a previously stored regression curve is used.
